(19) United States
(12) Patent Application Publication
(10) Pub. No.: US 2006/0001740 A1
(43) Pub. Date: Jan. 5, 2006

(54) Apparatus for dental diagnosis and treatment

(76) Inventors: Hidehiro Fujie, Yokohama-shi (JP); Susumu Fujie, Tokyo (JP)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/090,820

(22) Filed: Sep. 1, 2005

(30) Foreign Application Priority Data
Sep. 30, 2003 (JP) 2003-341763

(51) Int. Cl. A62B 1/04

(52) U.S. Cl. 348/66

(57) ABSTRACT

An apparatus for dental diagnosis and treatment includes: a dentist's chair disposed near a dental treatment table; an intraoral camera which can capture moving images in the patient's oral cavity and can be fixed near the patient's mouth; a first monitor installed at a position where the three parties comprising a dentist sitting on the dentist chair, the patient lying on his/her back on the dental treatment table, and a dental assistant assisting the diagnosis and treatment can see, the first monitor displaying the image captured by the intraoral camera, and being able to invert the image in the vertical direction and reverse the image in the lateral direction by the dentist; and a recording device which can record the images captured by the intraoral camera.

### BACKGROUND OF THE INVENTION

The present invention relates to an improvement in an apparatus for dental diagnosis and treatment having a dental treatment table provided with an intraoral camera and a monitor for displaying an image obtained by the intraoral camera, and adapted so that a dentist can carry out dental treatment while looking at a moving image in the oral cavity of a patient, which is displayed on the monitor.

An apparatus for dental diagnosis and treatment in prior art is an apparatus for dental diagnosis and treatment in which a dentist gives treatment while directly observing a site to be treated in the oral cavity, and when the dentist carries out treatment using the apparatus for dental diagnosis and treatment, as shown in FIG. 14 the dentist is forced to take an unnatural and uneasy posture with respect to the respective body position of a patient 15A on the dental treatment table 1A, such as bending his/her body or twisting his/her body to the left or right, in order to duly inspect the site to be treated. Consequently, many dentists are suffering from an occupational disease such as lumbago.

Operational accuracy required for treatment which involves grinding of a tooth is supposedly 0.2 mm. Therefore, the treatment of such an accuracy level with the naked eyes is an operation on the verge of the limit of discriminating power of the eye, and hence fatigue of the eyes becomes outrageous. Therefore, it is supposed that the treatment operated below the required treatment accuracy may be carried out under the existing circumstances.

In the dental treatment in prior art, there is a method of carrying out treatment of a site to be treated in the oral cavity, which is not visible directly from the dentist in terms of its angle, by looking at an image reflected in a dental mirror 48A as shown in FIG. 15 to FIG. 17. As shown in FIG. 16, the patient 15A is laid on the treatment table on his/her back, and a dentist 14A is sitting on a chair disposed on the side of the parietal region 15a of the patient 15A. This is a scene of treatment that the dentist carries out by looking at an occlusal surface 15b of a maxillary molar tooth reflected in the dental mirror 48A. The dentist 14A holds the dental mirror 48A with his/her left hand 47A, and looks at the occlusal surface 15b of a maxillary molar tooth reflected in the dental mirror 48A. FIG. 15 is an explanatory drawing devised to facilitate understanding, in which an alphabet F is attached on the occlusal surface 15b of a maxillary molar tooth on the right side R. In FIG. 16, which is a view of FIG. 15 seen from the opposite direction of FIG. 15, the alphabet F reflected in the dental mirror 48A is reversed with respect to left and right. In other words, the view of the occlusal surface of the maxillary molar tooth which the dentist 14A sees using the dental mirror 48A is a reversed image with respect to left and right of the real one.

Then, the dentist 14A holds a diagnosis and treatment tool 50A with his/her right hand 46A and moves the same along the surface of the occlusal surface 15b of the maxillary molar tooth downward. At this time, the diagnosis and treatment tool 50A which is reflected in the dental mirror 48A is also seen to be moved downward. When the diagnosis and treatment tool 50A is moved from the left side L to the right side R on the occlusal surface of the maxillary molar tooth, the diagnosis and treatment tool 50A reflected in the dental mirror 48A is also seen to be moved from the left side L to the right side R. Therefore, the dentist 14A does not move the diagnosis and treatment tool 50A in the wrong direction when he/she moves the same while looking at the mirror image reflected in the dental mirror 48A.

In the treatment carried out on the lingual-side surface of the mandibular molar tooth while looking at it with the naked eyes in prior art, the dentist pushes aside the patient's tongue which covers the tooth surface by using the dental mirror or the like held by his/her one hand, and moves the diagnosis and treatment tool using his/her another hand for treatment in a space created at this site. However, since it is a site which is difficult to be seen with the naked eyes, this type of treatment is performed with great difficulty. Even when an attempt is made to carry out the treatment while shooting pictures by the intraoral camera, since both hands of the dentist's are already occupied, he/she can use it only for the purpose of inspecting the state of the tooth surface but cannot use it for the purpose of performing the treatment.

There are some problems in the method of proceeding treatment while looking at the site to be treated with the dental mirror. In this method, the dental mirror is subject to fog up from breath of the patient. In addition, when grinding the tooth, splashing water ejected from the grinding tool may attach on the dental mirror and hinder the reflection of the dental mirror, which results in great difficulty in treatment. Therefore, a large majority of dentists cannot proceed the treatment while mirroring the site to be treated and looking at the image in the dental mirror, but use the dental mirror only for inspecting the state of the site to be treated before and after the treatment.

Describing the image obtained by many types of intraoral cameras in prior art, the intraoral camera has a lens at the side surface of a head portion. The intraoral camera is adapted so that the patient's face is displayed in the direction as the actual direction when capturing the image of the standing patient's face with the head portion faced upward. Therefore, when capturing an image of the patient's face with the head portion of the intraoral camera faced downward, the patient's face displayed on the monitor screen is a view turned by 180 degrees, that is, the view inverted and reversed. The image of the intraoral camera is an enlarged image of several-fold to a several tens-fold magnifications.

Subsequently, as shown in FIG. 18, when the patient 15A is laid on the dental treatment table on his/her back, and the dentist 14A sits on the dentist chair disposed on the side of the parietal region 15a of the patient 15A and captures an image of the labial-side surface of the maxillary anterior tooth 15c of the patient 15A, the image can be captured easily by setting a head portion 37A of an intraoral camera 12A to face toward the parietal region 15a of the patient 15A. In order to facilitate understanding, an alphabet J is attached to the labial-side surface of the maxillary anterior tooth 15c. When the image is displayed on a monitor 6A, the image is inverted and reversed on the screen in comparison with the actual labial-side surface of the maxillary anterior tooth 15c, which can be seen from the view point of the dentist 14A. In other words, when the image of the labial-side surface of the maxillary anterior tooth 15c is captured by the intraoral camera, the image is inverted and reversed in comparison with the actual oral cavity which can be seen from the view point of the dentist. Therefore, when the dentist moves his/her right hand 46A while looking at this image, the hand moves in the direction opposite from the intended direction vertically and laterally, and hence it is hardly possible to carry out treatment in this state.

Subsequently, as shown in FIG. 16, when capturing an image of the occlusal surface of a maxillary molar tooth with the patient laid on his/her back on the dental treatment table and the dentist seated on the dentist chair disposed on the side of the parietal region of the patient, the intraoral camera 12A in FIG. 18 is placed in the patient's oral cavity with the head portion 37A faced downward and with the lens faced upper jaw to capture the image of the patient's occlusal surface of a maxillary molar tooth. The image displayed on the monitor is inverted and reversed in comparison with the actual view. As already described above, when the dentist mirrors the occlusal surface of the maxillary molar tooth on the dental mirror 48A, the occlusal surface of the maxillary molar tooth is reversed. Nevertheless the dentist can move the diagnosis and treatment tool 50A to the intended direction without mistake while looking at the reversed image. Therefore, based on this principle, by inverting the image obtained by the intraoral camera 12A only in the vertical direction, the diagnosis and treatment tool 50A can be moved in the intended direction without mistake while looking at the resultant image.

The holding device for the intraoral camera in the related art is disclosed in JP-A-2001-112713. It seems that the intraoral camera can be moved freely in the oral cavity. However, when treatment is carried out within a small space of the oral cavity, the intraoral camera is inevitably placed at a position close to, or in contact with, the tongue or the lip since it is necessary to keep the intraoral camera apart from other diagnosis and treatment tools so as not to interfere therewith. Therefore, there arises a problem in that the intraoral camera is moved by being pushed by the tongue or the lip.

According to JP-A-7-275202, it is described that the treatment work can be proceeded while looking at the image obtained by the intraoral camera. However, in this apparatus, although the monitor for displaying the image can be inclined, the monitor image cannot be inverted and reversed, and hence the direction of movement of the dentist's hand does not agree with the movement of the dentist's hand on the monitor display in many cases while proceeding treatment work, and it has been very difficult to proceed the treatment work.

Likewise, according to the above-described JP-A-2001-112713, it is described that the treatment can be carried out while looking at the image captured by the intraoral camera. However, since the image cannot be reversed, it has been very difficult to proceed the treatment work.

Furthermore, in JP-A-2002-102168, there is a description regarding the necessity to reverse the image of the intraoral camera in the horizontal direction depending on the site to be captured an image. However, there are some cases where the direction of movement of the dentist's hand on the monitor screen differs in the vertical direction with respect to the actual movement of the dentist's hand, and hence it has been difficult to proceed the treatment work.

Also, in this medical system, an image reversal control circuit is provided in the main body, and is automatically controlled by comparing the amount of infrared rays from two infrared ray sensors. Therefore, when the two infrared sensors are located at the same distance from a subject to be examined, there is a case where the image reversal control circuit does not work even though it is necessary to reverse the image.

Also, according to JP-A-2002-125938, a medical system for displaying biological information of the patient is described. However, in this treatment method, since the dentist must always look into the patient's oral cavity during diagnosis and treatment, it is troublesome to look both the monitor and the patient's oral cavity alternately, and consequently, it only resulted in hindering the dentist's concentration on diagnosis and treatment.

### SUMMARY OF THE INVENTION

The present invention is intended to solve the above-described problems, and in particular, it is an object of the present invention to achieve dental treatment which can be proceeded while allowing the three parties of a dentist, a patient, and a dental assistant to see the image of an intraoral camera in a natural state. An apparatus for dental diagnosis and treatment according to the present invention includes: a dentist's chair disposed near a dental treatment table; an intraoral camera which can capture a moving image in the patient's oral cavity and can be fixed near the patient's mouth; a first monitor installed at a position where the three parties of the dentist sitting on the dentist chair, the patient lying on his/her back on the dental treatment table, and the dental assistant assisting the diagnosis and treatment can see, wherein the first monitor displaying the image captured by the intraoral camera, and being able to invert and reverse the image in the vertical direction and lateral direction by the operation of a foot switch by the dentist; and a recording device which can record the images captured by the intraoral camera by the operation of the foot switch by the dentist. As means for allowing the aforementioned three parties to see the image of the intraoral camera, three-specific monitors including a dentist-specific monitor, a patient-specific monitor, and a dental-assistant-specific monitor can be used. Alternatively, the dentist-specific monitor with a patient-specific mirror and a dental-assistant-specific mirror both of which can reflect the display of the dentist-specific monitor may also be used.

### BRIEF DESCRIPTION OF THE DRAWINGS

FIG. 1 is a perspective view showing a first embodiment of the present invention;

FIG. 2 is a perspective view of a camera holding device;

FIG. 3 is an enlarged perspective view of a principal portion of the camera holding device, wherein FIG. 3(A) shows a locking mechanism, FIG. 3(B) shows a second arm, and FIG. 3(C) shows a first arm;

FIG. 4 is a perspective view showing a vacuum device;

FIG. 5 is a perspective view showing a patient and the vacuum device;

FIG. 6 is a perspective view showing the relation between a site to be diagnosed and treated which the dentist actually sees, and a monitor image of the intraoral camera;

FIG. 7 is a perspective view showing a second embodiment of the present invention;

FIG. 8 is a perspective view showing a third embodiment of the present invention;

FIG. 9 is a perspective view showing a fourth embodiment of the present invention;

FIG. 10 is a perspective view showing the intraoral camera, wherein FIG. 10(A) is a side view and FIG. 10(B) is a front view;

FIG. 11 is a perspective view showing a fifth embodiment of the present invention, wherein FIGS. 11(A), 11(B), 11(C) and 11(D) are drawings showing different intraoral camera mounting positions;

FIG. 12 is a perspective view showing a sixth embodiment of the present invention;

FIG. 13 is a perspective view showing a seventh embodiment of the present invention;

FIG. 14 is a perspective view showing postures of the dentist during diagnosis and treatment in the related art;

FIG. 15 is a plan view showing an occlusal surface of a maxillary molar tooth;

FIG. 16 is a perspective view showing an example of how a dental mirror is used in the related art;

FIG. 17 shows a state in which the occlusal surface of a maxillary molar tooth is reflected in the dental mirror in the related art;

FIG. 18 is a perspective view showing the relation between the site to be diagnosed and treated which the dentist actually sees and the monitor image of the intraoral camera in the related art; and

FIG. 19 is a block diagram showing an image inversion control system according to the present invention.

### DETAILED DESCRIPTION OF THE PREFERRED EMBODIMENTS

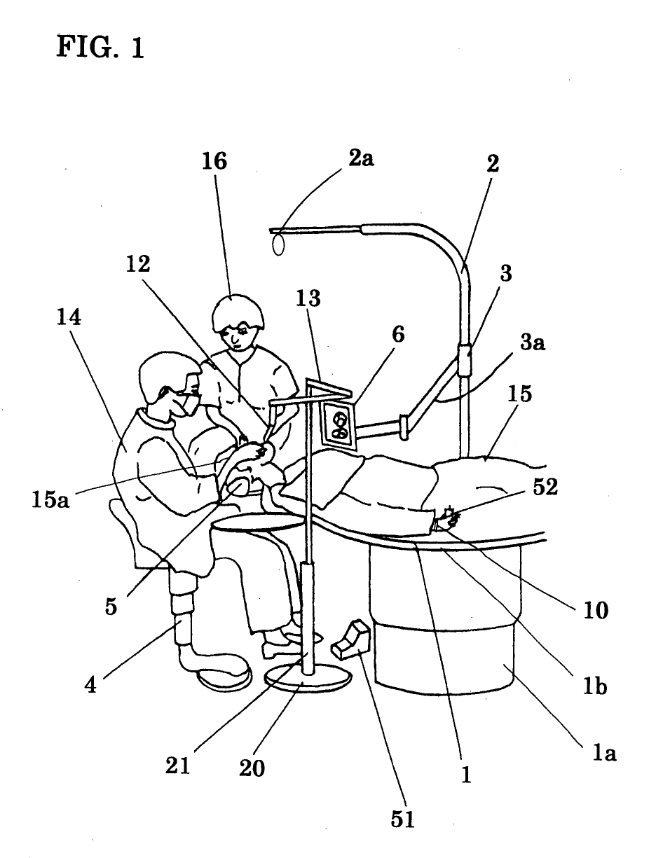

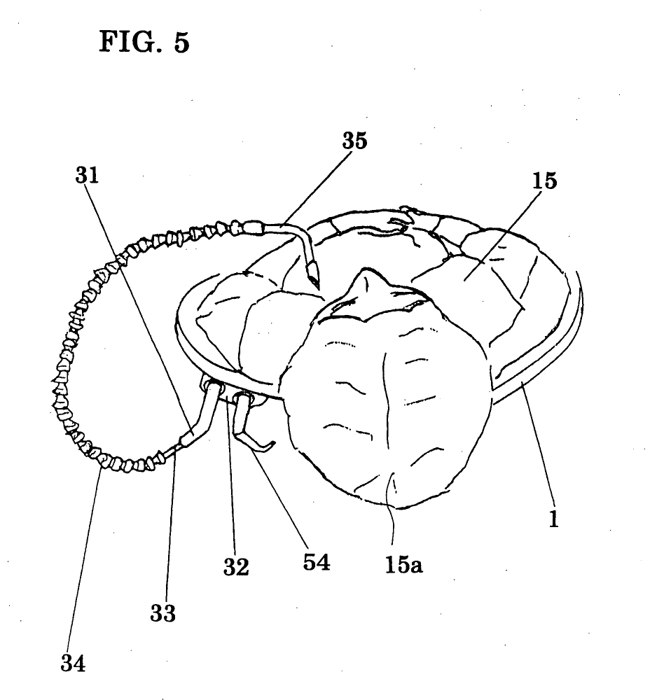

Referring now to FIG. 1 to FIG. 6, a first embodiment of the present invention will be described.

A dental treatment table 1 includes a back plate 1b supported by a base member 1a. The back plate 1b is set to be substantially parallel with the floor surface, and a headrest 5, a vacuum device 32, a three-way syringe 54, and so on are provided at the rear end thereof.

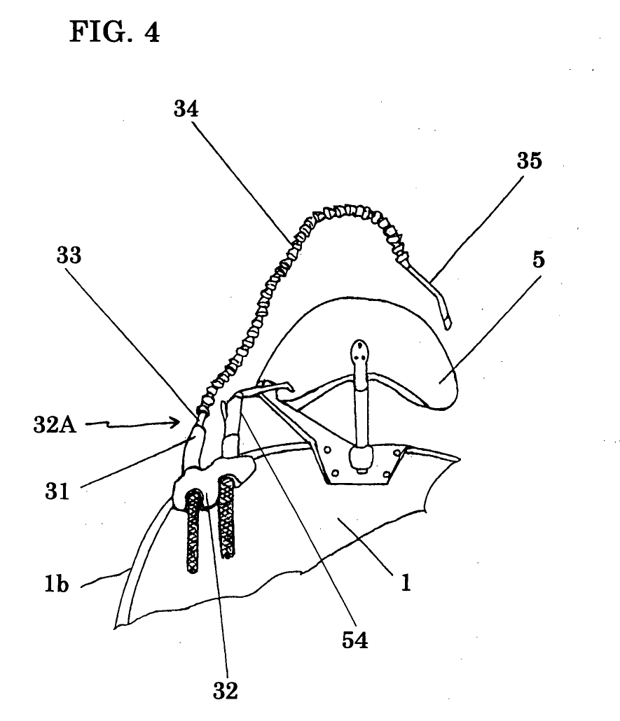

As shown in FIG. 4, the vacuum device 32A includes a vacuum hose 31 fixed to a vacuum hose fixing base 32, a hollow flexible tube extension hose 34 connected to the vacuum hose 31 via a joint member 33, and a vacuum tip 35 detachably attached to the distal end of the hose 34. The flexible tube extension hose 34 has an adequate hardness such as to be deformed when a force is exerted, and kept as is when no force is exerted. It is also possible to attach the vacuum tip 35 directly to the vacuum hose 31 as in the related art.

Disposed near the dental treatment table 1 are a dentist chair 4 on which a dentist 14 sits, a lamp post 2 for supporting an illumination lamp 2a, a camera holding device 13 for supporting the intraoral camera 12, and a foot switch 51 for operating the intraoral camera 12 or the recording device, and so on.

The dentist chair 4 is provided on the side of the headrest 5, and is adjusted in position so that the dentist 14 sitting on this chair 4 can see inside the oral cavity of the patient 15 well.

The lamp post 2 is formed into an L-shape, and an illumination lamp 2a is provided on the horizontal portion thereof, and a monitor mounting device 3 is provided on the vertical portion thereof. A first monitor 6 is fixed to the monitor mounting device 3 via an arm 3a. The arm 3a is extensible, and the first monitor 6 is rotatably connected to the arm 3a.

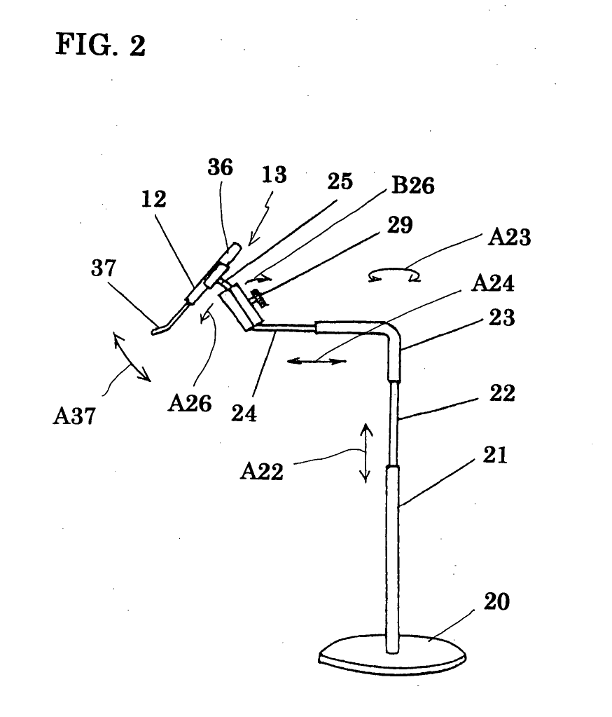

The camera holding device 13 includes, as shown in FIG. 2, a first link 22 mounted on a pole 21, which is set up at the center of a floor disk 20, so as to be capable of sliding in the axial direction of the pole 21, a second link 23 slidably and rotatably mounted to the first link 22. The second link 23 is bent to the horizontal direction on the upper side, and a first arm 24 is slidably mounted to the horizontal portion of the second link 23. Mounted at the other end of the first arm 24 via a locking mechanism 26 is the intraoral camera 12. Since the holding device 13 has the structure as described above, it can be displaced in a direction indicated by an arrow A22, that is, in the vertical direction, and in a direction indicated by an arrow A24, that is, in the horizontal direction, and in a direction indicated by an arrow A23, that is, in the rotational direction.

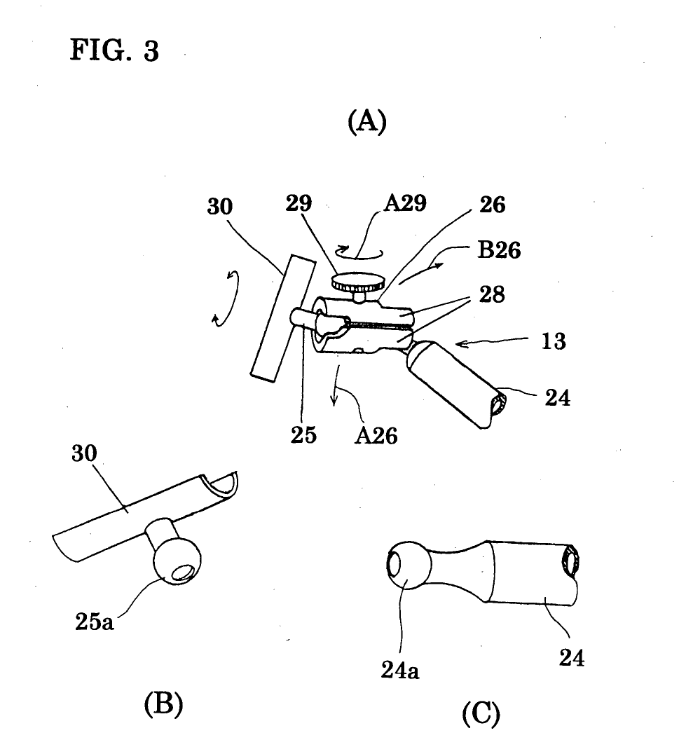

In the locking mechanism 26 of the camera holding device 13, spherical engaging members 24a, 25a at the ends of the first arm 24 and the second arm 25 are pivotally supported at a position clamped between recesses on a pair of upper and lower pressing plates 28 as shown in FIG. 3. An adjusting bolt 29 is screwed through the upper and lower pressing plates 28 at the center portion of the pressing plates 28. When the adjusting bolt 29 is turned and tightened, the upper and lower pressing plates 28 are pressed against the engaging members 24a, 25a, whereby the pivotal movement of the first arm 24 and the second arm 25 is constrained, and the position of the intraoral camera 12 is fixed. A camera mounting base 30 is provided at the other end of the second arm 25, and the intraoral camera 12 is mounted to the mounting base 30. It is also applicable to form the pressing plates 28 of ferromagnetic material and use magnet for the engaging members 24a, 25a for constituting the ball joint magnet to achieve dual effect with an electromagnetic lock.

The intraoral camera 12 is a camera to be inserted into the patient 15's oral cavity to capture a moving image of the interior of the oral cavity, and includes a camera body 36 and a head portion 37 provided at the distal end of the camera body 36. The head portion 37 is provided with one lens (not shown). A cover formed of hydrophilic material is provided on the surface of the lens as needed.

The image captured by the intraoral camera 12 is transmitted to a first monitor 6 by a fixed line or wireless. The first monitor 6 is adjusted in position so that the three parties of the dentist 14, the patient 15, and the dental assistant 16 can see well.

The apparatus for dental diagnosis and treatment includes an image inversion control means, a patient's biological information detecting means, a patient's will expressing means, a recording device, a dental grinding tool, and a medical tool.

The image inversion control means is a means for converting the image on the first monitor 6 into at least a vertically inverted image and a laterally reversed image, and for example, an image inversion control circuit 60 is used.

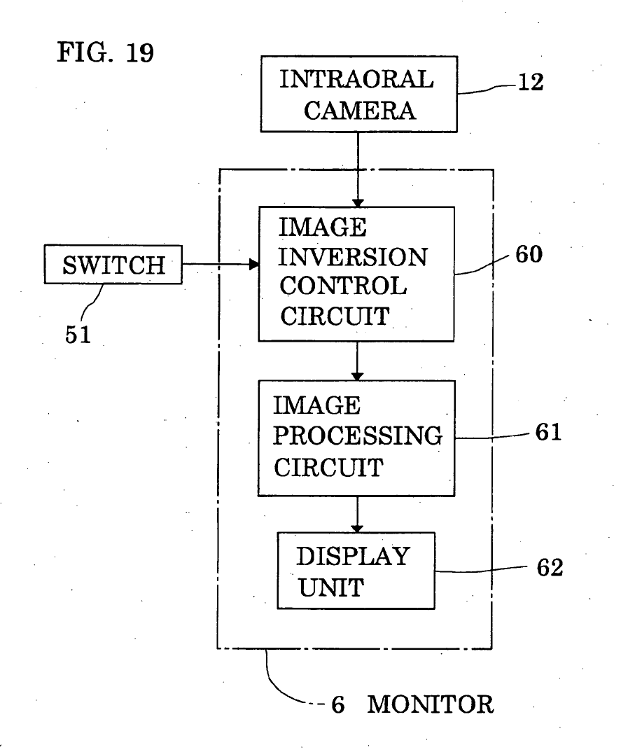

The image inversion control circuit 60 is provided in the monitor 6, and as shown in FIG. 19, is connected to the intraoral camera 12, and a switch, such as the foot switch 51 which the dentist 14 operates. The inverted or reversed image in the image inversion control circuit is outputted to a display unit 62 via an image processing circuit 61, and displayed. Since the image inversion control circuit 60 is integrated into the monitor 6 as described above, the image can be inverted or reversed by using the existing intraoral camera in which the image inversion control circuit 60 is not incorporated.

The patient's biological information detecting means is a means for measuring the heart rate, blood pressure, body temperature, frequency of respiration, sweating amount, saturation ratio of oxygen in the blood, electrocardiogram, and checking the physical condition of the patient. For example, a detector 10 is used for detecting the blood pressure, body temperature, heart rate and the like. And the detected data is displayed on the first monitor 6.

The patient's will expressing means is a means that the patient receiving the treatment with his/her mouth open uses for transmitting his/her will such as a tired or discomfort feeling to the dentist, and a portable transmitter 52 may be used. The transmitter 52 displays caution by characters or symbols on the first monitor 6 when the patient presses a transmission button by his/her hand.

The recording device is a device for recording the images captured by the intraoral camera, and recording starts when the dentist operates the foot switch 51.

The dental grinding tool to be provided may be, for example, handpieces such as a turbine, a micro-motor, and the like, and the medical tool to be provided may be handpieces such as an ultrasonic scaler, an electric knife, or a laser device.

Subsequently, the operation of the present embodiment will be described.

As shown in FIG. 1, the patient 15 is laid on his/her back on the dental treatment table 1, the detector 10 is attached to the patient 15's body, and the transmitter 52 is held by the patient's hand. The dentist 14 adjusts the position or angle of the first monitor 6, so that the three parties of the dentist 14, the patient 15, and the dental assistant 16 can see the first monitor 6 in a natural unforced posture. The first monitor 6 is faced substantially exactly toward the dentist 14.

The dentist 14 sits on the dentist chair 4, holds the intraoral camera 12 with his/her left hand 47, captures an image of the site to be diagnosed and treated in the oral cavity of the patient 15 with the lens faced toward the site, and carries out diagnosis and treatment while viewing the image displayed on the first monitor 6. When the site to be treated is the labial-side surface of the maxillary anterior tooth 15c, the image can be captured easily when the head portion 37 of the intraoral camera 12 is faced toward the parietal region 15a of the patient 15.

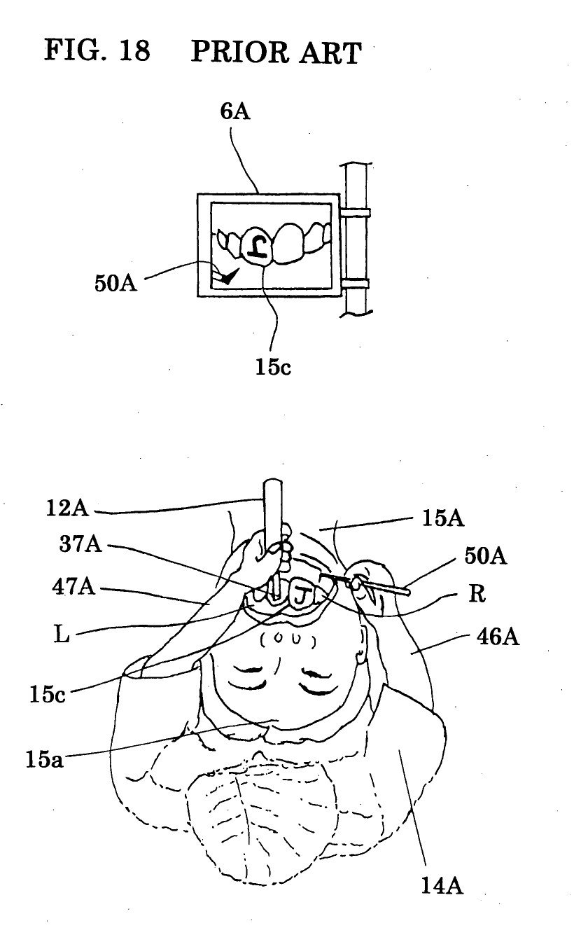

However, when the intraoral camera 12 is oriented in such a direction, the vertically inverted and laterally reversed image is displayed on the first monitor 6A when viewed from the dentist 14A in the related art (see FIG. 18).

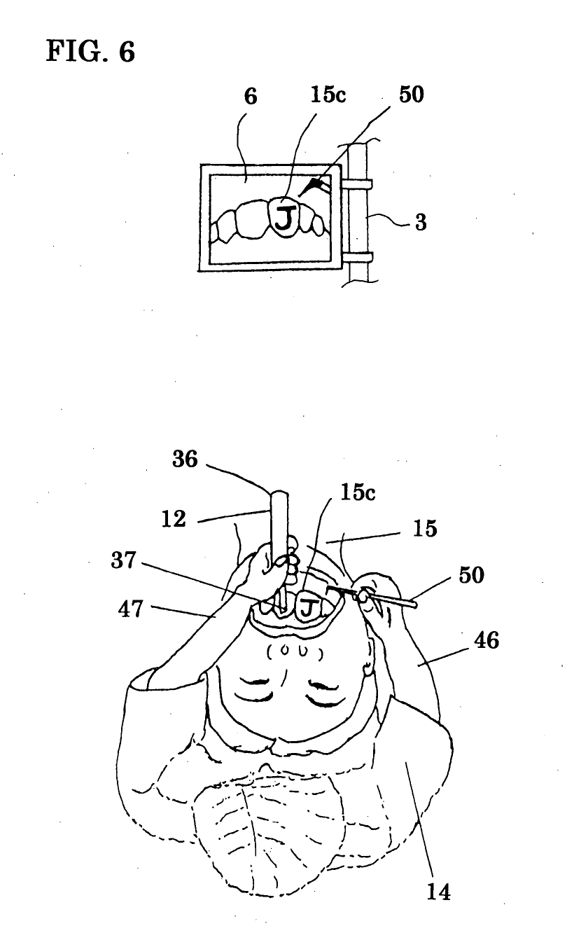

Accordingly, in the present invention, the dentist 14 presses the foot switch 51 with his/her foot and activates the image inversion control means. Then, the same image as the view of the actual labial-side surface of the maxillary anterior tooth 15c seen from the dentist 14's eye view is displayed on the screen of the first monitor 6 as shown in FIG. 6. Therefore, the dentist 14 can carry out the diagnosis and treatment without a feeling of strangeness.

In order to facilitate understanding of the significance of inversion, an alphabet J is attached to the labial-side surface of the maxillary anterior tooth 15c.

Since the image inversion control means is operated by the foot switch 51, the dentist 14 can perform switching operation without discontinuing the operation with his/her hand and without contaminating his/her hand.

The dentist 14 fixes the intraoral camera 12 to the camera mounting base 30 of the camera holding device 13 as needed, adjusts the camera 12 to a desired position, and carries out diagnosis and treatment using the diagnosis and treatment tool 50. Since the camera holding device 13 can be displaced in the vertical and lateral directions, the dentist 14 can easily move the intraoral camera 12 to a desired position. Owing to the camera holding device 13, the dentist's both hands are free and can carry out diagnosis and treatment with his/her both hands. Although the dentist 14 carried out diagnosis and treatment, holding the intraoral camera 12 in his/her hand at the beginning in the aforementioned embodiment, it is also possible to move the intraoral camera 12 to a desired position in a state in which the intraoral camera 12 is already fixed to the camera holding device 13 in the first place.

Since the first monitor 6 is disposed so that the three parties of the dentist 14, the patient 15, and the dental assistant 16 can see in an unforced posture, the dentist 14 can carry out treatment while looking at the first monitor 6. Therefore, since it is not necessary to take an unnatural posture in order to look at the site to be treated directly with his/her eyes, the dentist 14 can prevent the disorder of the body caused by the posture during diagnosis and treatment from occurring.

Since the patient 15 can see the treatment carried out in his/her own oral cavity through the image that is captured by the intraoral camera 12 and is displayed on the first monitor, he/she can undergo diagnosis and treatment without anxiety.

Since the dental assistant 16 can also see the first monitor 6 easily, he/she can know the state in the oral cavity of the patient 15 and hence can perform adequate assistance for diagnosis and treatment. For example, the dental assistant 16 can know the appropriate timing to suck water accumulated in the oral cavity of the patient 15, and can insert the vacuum tip 35 into the oral cavity of the patient 15 and suck the water at the appropriate timing.

Since the vacuum tip 35 is connected to the flexible tube extension hose 34 having a suitable hardness, when the dental assistant 16 inserts the vacuum tip 35 into the oral cavity of the patient 15 and moves the same to a predetermined position, it is fixed at the position and hence does not move even when he/she releases his/her hand from the vacuum tip 35. Accordingly, since the dental assistant 16 is released from a simple work of holding the vacuum tip 35 for a long time, his/her mental burden is also reduced.

When it is desired to store the record of diagnosis and treatment of the dental treatment, the dentist 14 presses the foot switch 51 by his/her foot to activate the recording device, and records the image obtained by the intraoral camera 12. Owing to the recording, a detailed and accurate record of the diagnosis and treatment is achieved, and can be used for transmission of the dental diagnosis and treatment technology. In other words, by recording and using the image captured by the intraoral camera 12, succession of technology which becomes extremely accurate in comparison with the conventional method using characters, illustrations, or photos is achieved.

There is a case where the pulse rate of the patient 15 may significantly increase, for example, while anesthesia is applied. Such variations in the pulse rate can be detected by the detector 10, and the detected information is displayed on the first monitor 6. Therefore, the dentist 14 who carries out diagnosis and treatment while looking at the first monitor 6 can notice such abnormality immediately, and hence can cope with it appropriately.

When the patient 15 feels pain or discomfort, for example, when he/she is trying not to swallow up water containing ground chip of the tooth accumulated in his/her oral cavity for a long time without saying anything, he/she pushes a button on the transmitter 52 in his/her hand. Then, information from the transmitter 52 is displayed on the first monitor 6. Therefore, the dentist 14, who is carrying out diagnosis and treatment while looking at the first monitor 6, can take notice of the patient's request. Therefore, he/she can discontinue the diagnosis or treatment immediately and take required action.

With this apparatus for dental diagnosis and treatment, the positional relation between the dentist and the patient's mouth can be kept within a constant range. Therefore, the movement of the eyes, arms, wrists, or fingertips of the dentist is limited within a certain range, and hence he/she can carry out diagnosis and treatment by moving his/her own hand without looking at the area around his/her hand. In addition, since the dentist can carry out diagnosis and treatment on the dentist chair in a natural unforced posture which does not give burden to the body, the dentist can be prevented from getting tired soon, and hence the quality of diagnosis and treatment can be improved.

With this apparatus for dental diagnosis and treatment, the dentist can carry out treatment while looking at all the parts in the oral cavity displayed on the monitor in an enlarged scale without using the dental mirror. Therefore, the problem which occurs when using the dental mirror such that the surface of the dental mirror is fogged up or attached with water drops and hence cannot reflect the image can be overcome. Also, the problem such that the dentist can use only one hand due to the use of dental mirror is also solved.

### Second Embodiment

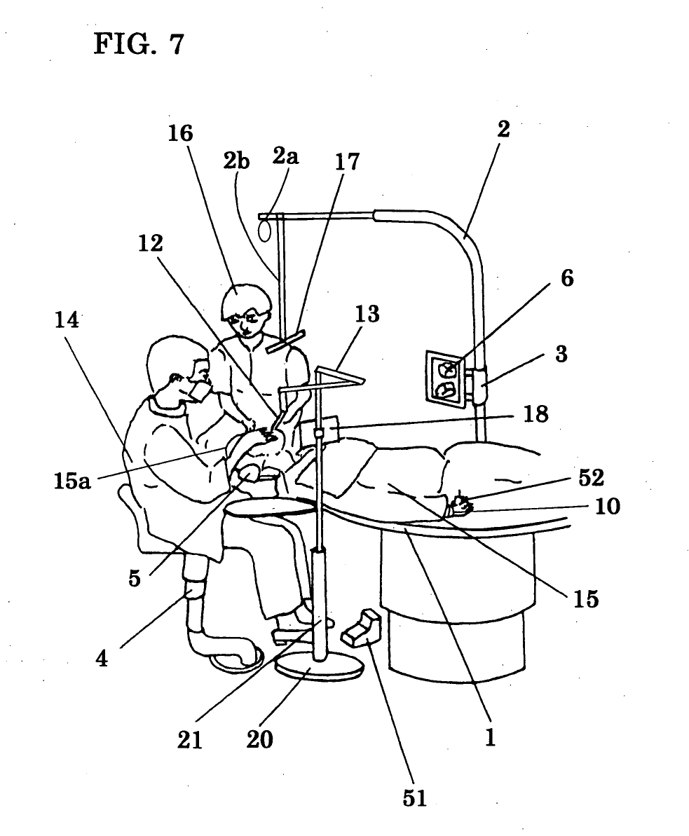

Referring to FIG. 7, a second embodiment will be described. The same reference numerals as in FIG. 1 to FIG. 6 represent the same names and functions.

The difference between this embodiment and the first embodiment is in that a patient-specific mirror 17 and a dental-assistant-specific mirror 18 are provided in addition to the first monitor 6. The patient-specific mirror 17 is installed at a position where the patient 15 lying on his/her back on the dental treatment table 1 can see best, and its angle is adjusted so as to reflect the display of the first monitor 6. For example, the patient-specific mirror 17 is rotatably provided on a connecting member 2b, which is provided at the distal end of the lamp post 2 in the vertical direction, and the height or the inclination angle thereof is adjustable. The patient-specific mirror 17 is located substantially right above the eyes of the patient 15, and is disposed at a position where it can be seen easier than the first monitor 6 by the patient 15.

The dental-assistant-specific mirror 18 is installed at a position where the dental assistant 16 can see best while carrying out assistant work for diagnosis and treatment, and its angle is adjusted so as to reflect the display of the first monitor 6. For example, the dental-assistant-specific mirror 18 is disposed at the upper portion of the pole 21 of the camera holding device 13 so as to be just opposite to the dental assistant 16.

In this embodiment, since the patient 15 and the dental assistant 16 can look at the mirrors 17, 18 of their own, they do not need to directly look at the first monitor 6. Therefore, the first monitor 6 can serve as a dentist-specific monitor, and hence it can be fixed to a position where the dentist 14 can see best and where the getting on and off action of the patient 15 with respect to the dental treatment table 1 is not hindered.

### Third Embodiment

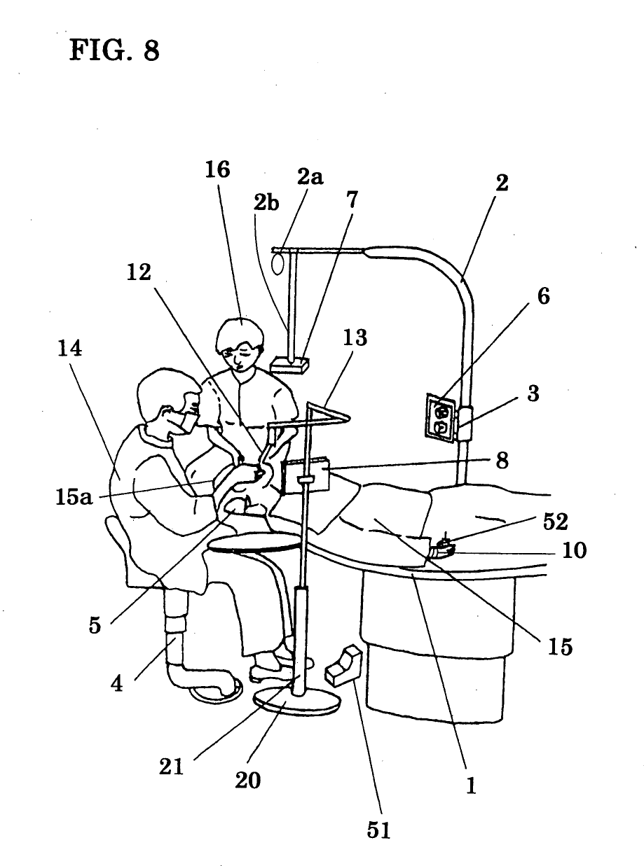

Referring to FIG. 8, a third embodiment of the present invention will be described. The same reference numerals as in FIG. 1 to FIG. 6 represent the same names and functions.

The difference between this embodiment and the first embodiment is in that a second monitor 7 for a patient and a third monitor 8 for a dental assistant are provided in addition to the first monitor 6.

The second monitor 7 is installed at a position where the patient 15 lying on his/her back on the dental treatment table 1 can see best. For example, the second monitor 7 is rotatably provided on the connecting member 2b, which is provided at the distal end of the lamp post 2 in the vertical direction, and the height or the inclination angle thereof is adjustable. The second monitor 7 is located at a position where it can be seen easier than the first monitor 6 by the patient 15, and is positioned substantially right above the eyes of the patient 15.

The third monitor 8 is disposed at a position where the dental assistant 16 can see best while carrying out assistant work for diagnosis and treatment. For example, the third monitor 8 is rotatably disposed at the upper portion of the pole 21 of the camera holding device 13 so as to be just opposite to the dental assistant 16.

In this embodiment, since the patient 15 and the dental assistant 16 can look at the monitors 7, 8 of their own, they do not need to directly look at the first monitor 6. Therefore, the first monitor 6 can serve as a dentist-specific monitor, and hence it can be fixed to a position where the dentist 14 can see best and where the getting on and off action of the patient 15 with respect to the dental treatment table 1 is not hindered.

Incidentally, the output information about the patient obtained by the biological information detecting means and the patient's will expressing means can be adapted to be displayed on the second monitor 7 and the third monitor 8 in addition to the first monitor 6.

### Fourth Embodiment

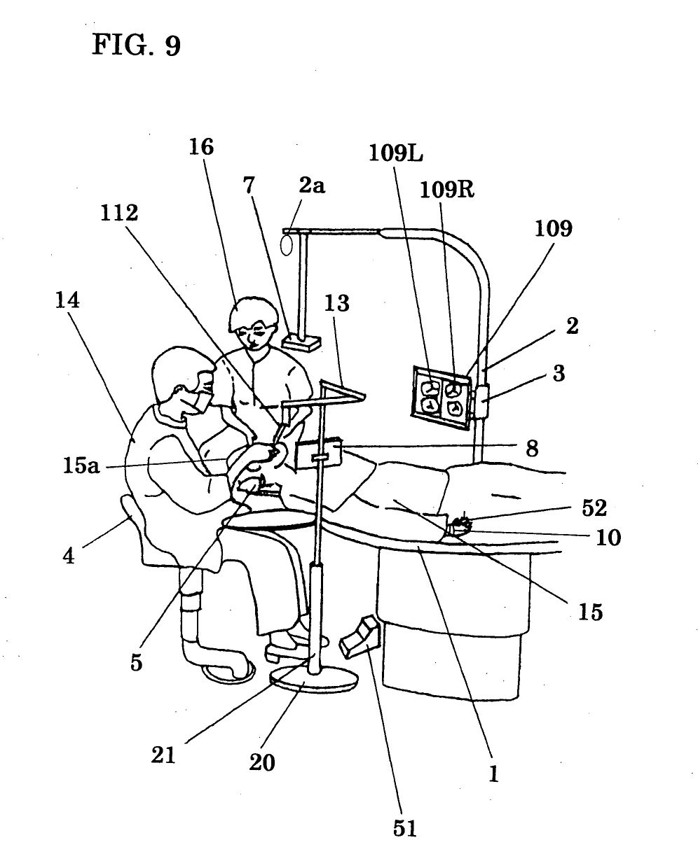

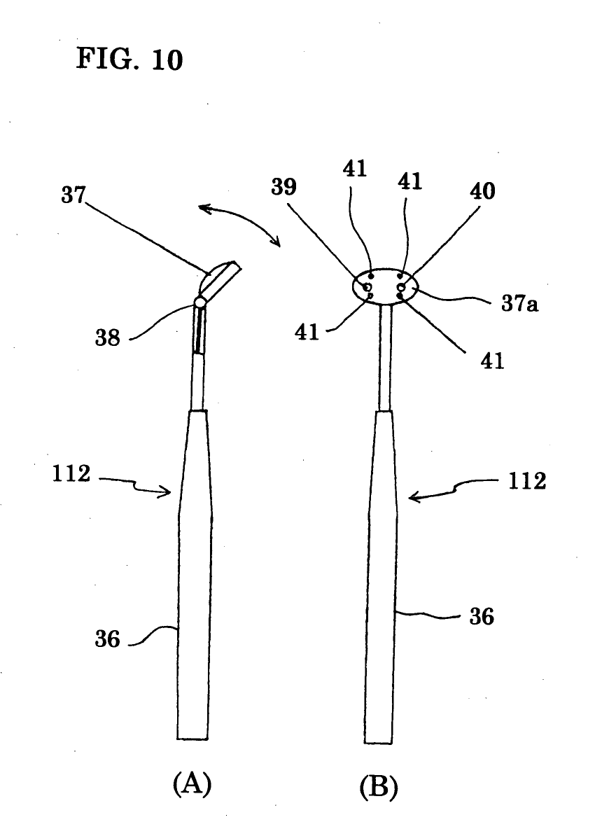

Referring now to FIG. 9 and FIG. 10, a fourth embodiment of the present invention will be described. The same reference numerals as in FIG. 1 to FIG. 8 represent the same names and functions.

The difference between this embodiment and the first, second and third embodiments is in that a camera 112 having two lenses is used as the intraoral camera, and a two-window monitor 109 is employed as the first monitor.

The intraoral camera 112 is provided with the camera body 36 and the head portion 37. The head portion 37 is rotatably connected to the camera body 36 via a hinge 38, and an upper surface 37a thereof is provided with a first lens 39, a second lens 40, and some lamps 41. The both lenses 39, 40 are disposed in parallel at a predetermined distance, and their angles are adjusted so that they can capture the images of the identical site to be diagnosed and treated from slightly different directions. The lamps 41 are disposed so that the lenses 39, 40 lie in between the lamps 41, respectively.

In this embodiment, since the intraoral camera 112 is adapted so that the first lens 39 and the second lens 40 can capture the images of the identical site to be diagnosed and treated from slightly different directions, and can display two images separately side by side on the two-window monitor 109, the dentist 14 looks at the left display 109L with his/her left eye and at the right display 109R with his/her right eye. Accordingly, the dentist 14 can recognize a subject being captured as a three-dimensional object.

The dentist 14 proceeds the diagnosis and treatment while viewing the two-window monitor 109, and the images on the two-window monitor 109 can be at least converted into vertically inverted images and laterally reversed images and also recorded by the operation of the foot switch 51 by the dentist 14.

Since the camera body 36 and the head portion 37 are connected by a hinge, the head portion 37 can be bent at an arbitrary angle. Therefore, the dentist can capture images of all the parts in the oral cavity with the lenses 39, 40 oriented accurately thereto.

Since the lamps 41 are built in the intraoral camera 112, the site to be treated in the oral cavity of the patient 15 can be illuminated thereby. Therefore, it is not necessary to illuminate the face of the patient 15 from above the dental treatment table 1, and hence the patient 15 need not suffer from glare during diagnosis and treatment, and can undergo diagnosis and treatment without uneasiness. In addition, since electric power for the illumination lamp 2a is not necessary, it also contributes to power saving.

### Fifth Embodiment

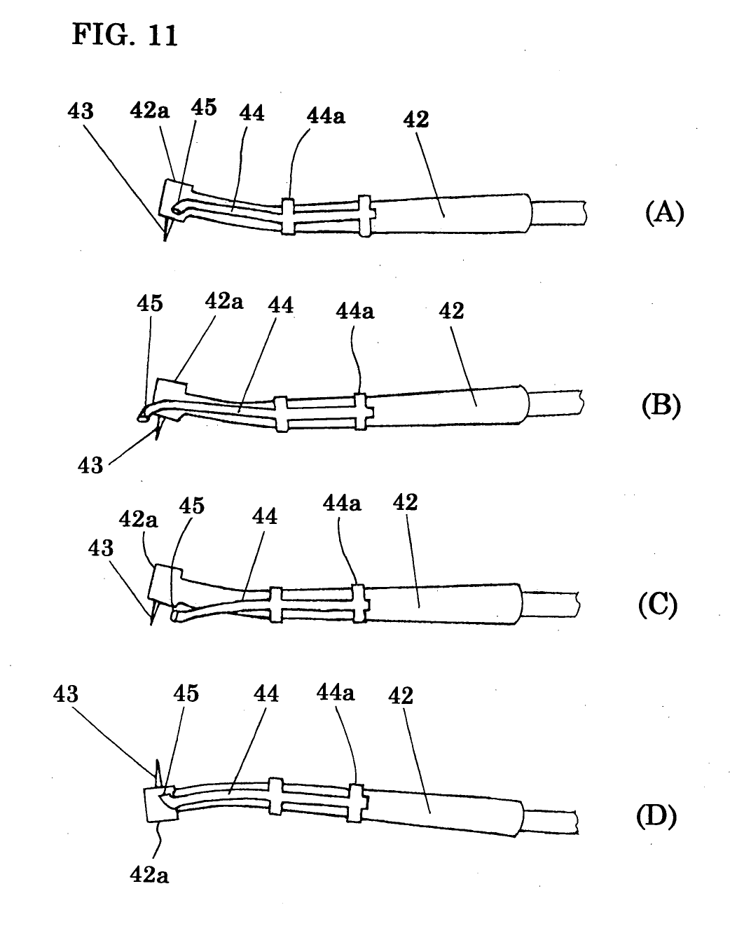

Referring to FIG. 11, a fifth embodiment of the present invention will be described. The same reference numerals as in FIG. 1 to FIG. 9 represent the same names and functions.

The difference between this embodiment and the first, second, third and fourth embodiments is in that an intraoral camera 44 is detachably mounted to the turbine handpiece 42.

A grinding bur 43 is provided at the distal end of the handpiece 42, and the intraoral camera 44 having a lens 45 at the distal surface thereof is provided on the side surface thereof. The lens 45 of the camera 44 is fixed by a holder 44a so that the grinding bur 43 is positioned substantially at the center of the image in the intraoral camera 44. The mounting position is selected as needed, and at least four positions as shown in FIG. 11(A) to FIG. 11(D) are required. The lens 45 is disposed on the side of the head portion 42a as shown in FIG. 11(A) and FIG. 11(D), or the lens 45 is disposed at a position projecting forward from the head portion 42a as shown in FIG. 11(B), or the lens 45 is disposed at a position downwardly of the head portion 42a as shown in FIG. 11(C).

In the present embodiment, the dentist can capture an image of the site to be treated without operating the intraoral camera, and can grind a tooth while looking at the image.

The intraoral camera 44 can be detachably mounted not only to a turbine handpiece, but also to a micro-motor handpiece as a tooth grinding tool, or to handpieces such as an ultrasonic scaler, an electric knife, or a laser device as medical tools.

### Sixth Embodiment

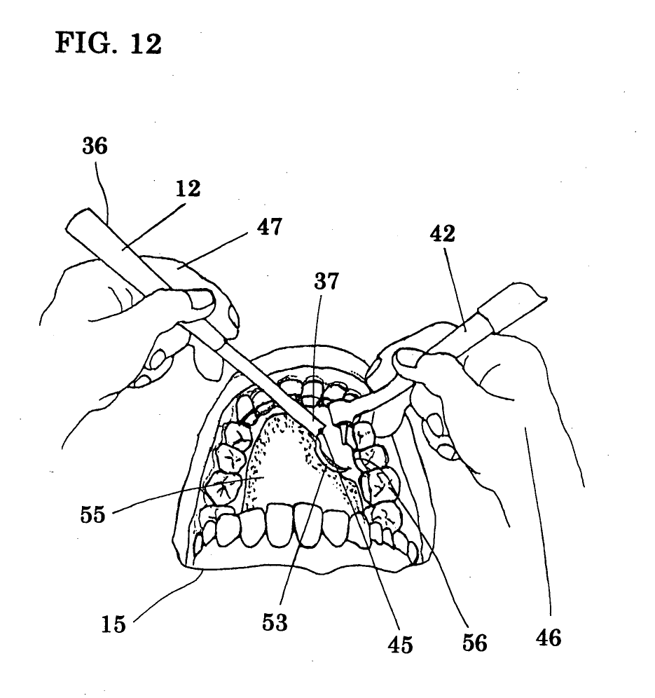

Referring to FIG. 12, a sixth embodiment of the present invention will be described. The same reference numerals as in FIG. 1 to FIG. 8 represent the same names and functions.

The difference between this embodiment and the first, second and third embodiments is in that a tongue depressor 53 is detachably attached at the head portion 37 of the intraoral camera 12.

In the case where a tongue 55 intercepts the visual field when capturing the image by the intraoral camera 12 and hence the image cannot be captured, the dentist attaches the tongue depressor 53 at the head portion 37. Subsequently, the dentist 14 holds the turbine handpiece 42 in his/her right hand 46, and holds the camera body 36 of the intraoral camera 12 in his/her left hand 47. Then, the distal end thereof is inserted into the oral cavity of the patient and depresses the tongue 55 with the tongue depressor 53 to move the tongue 55 away from the tooth surface. In this state, the image of the lingual-side surface 56 of the mandibular molar tooth is captured by the lens 45 provided at the distal end of the camera 12, and the grinding bur of the handpiece 42 is moved for treatment in the space formed at this part. Incidentally, with respect to the tongue depressor 53, several kinds of shapes are required according to the position of a site to be captured.

### Seventh Embodiment

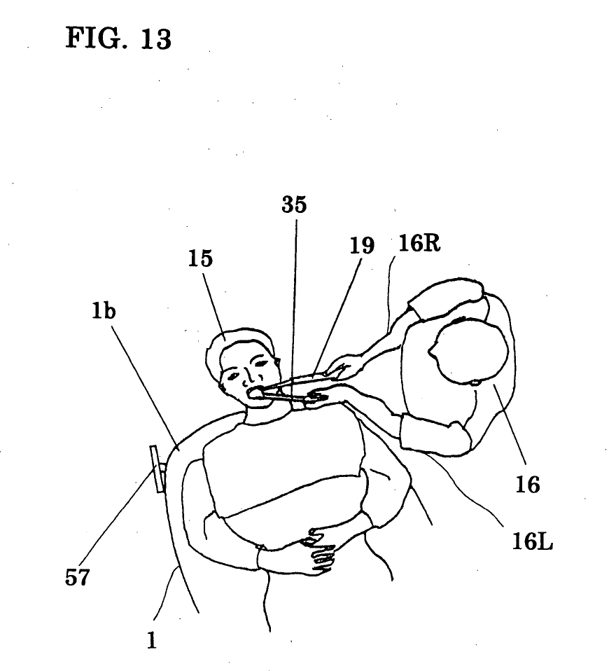

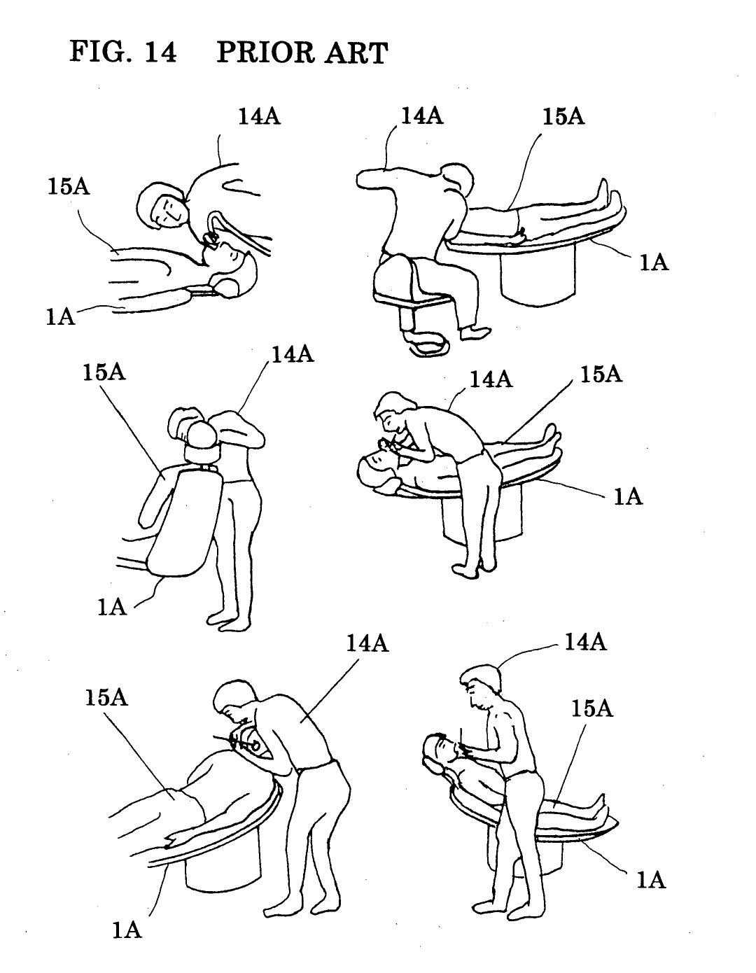

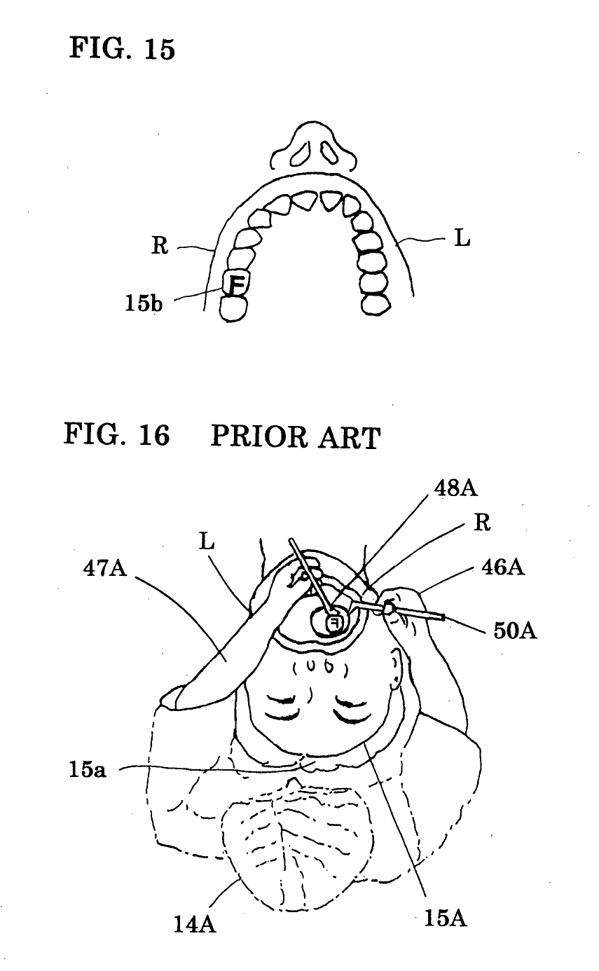

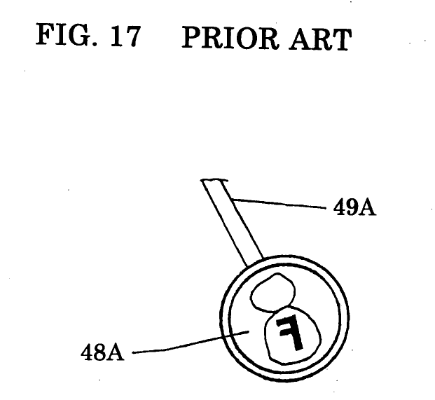

Referring now to FIG. 13, a seventh embodiment of the present invention will be described. The same reference numerals as in FIG. 1 to FIG. 8 represent the same names and functions.

The difference between this embodiment and the first, second, third and fourth embodiments is in that a dental-assistant-specific camera 19 is provided in addition to the intraoral camera 12.

The dental assistant 16 holds the dental-assistant-specific camera 19 in his/her right hand 16R, captures the image in the oral cavity of the patient 15 when needed, and sees the image in an auxiliary monitor 57. The auxiliary monitor 57 is fixed to the back plate 1b at a position where the dental assistant 16 can see easily. Then, for example, when water is accumulated in the oral cavity, he/she holds the vacuum tip 35 in his/her left hand 16L, inserts the distal end thereof into the oral cavity, and starts suction. In this manner, the dental assistant 16 can grasp the state in the oral cavity of the patient 15 at any time, and can carry out necessary treatment. The dental-assistant-specific camera 19 can be formed integrally with the vacuum tip 35 or the three-way syringe 54. Alternatively, the dental-assistant-specific camera 19 can be detachably mounted to the vacuum tip 35 or to the three-way syringe 54.

1. An apparatus for dental diagnosis and treatment comprising:
a dentist's chair disposed near a dental treatment table;
an intraoral camera which can capture moving images in a patient's oral cavity; and
a monitor installed at a position where three parties comprising a dentist sitting on the dentist chair, a patient lying on his/her back on the dental treatment table, and a dental assistant assisting the diagnosis and treatment can see, wherein the monitor displays the image captured by the intraoral, camera and is able to invert the image in a vertical direction and reverse the image in a lateral direction by operation of a switch by the dentist.

2. The apparatus for dental diagnosis and treatment according to claim 1, further comprising:
a patient-specific mirror installed at a position where the patient lying on his/her back on the dental treatment table can see, and being adjusted at an angle so as to reflect a display of the monitor; and
a dental-assistant-specific mirror installed at a position where the dental assistant can see while carrying out assistant work for diagnosis and treatment, and being adjusted at an angle so as to reflect the display of the monitor.

3. The apparatus for dental diagnosis and treatment according to claim 1, further comprising:
a second monitor for displaying an image obtained by the intraoral camera, and installed at a position where the patient lying on his/her back on the dental treatment table can see; and
a third monitor for displaying an image obtained by the intraoral camera, and installed at a position where the dental assistant can see while carrying out assistant work for diagnosis and treatment.

4. The apparatus for dental diagnosis and treatment according to claim 1, wherein:
the intraoral camera comprises two lenses disposed in parallel with each other so as to be capable of capturing the images of an identical subject simultaneously from different directions; and
the monitor comprises a two-window monitor, said two-window monitor providing a three-dimensional view by using two images obtained from the two lenses of the intraoral camera.

5. The apparatus for dental diagnosis and treatment according claim 1, further comprising:
a dental-assistant-specific camera so that the dental assistant can capture an assistant image by using it with their hand to see an interior of the oral cavity, wherein the assistant image obtained by the dental-assistant-specific camera can be displayed on an auxiliary monitor.

6. The apparatus for dental diagnosis and treatment according to claim 1, further comprising:
a camera holding device integral with the intraoral camera.

7. The apparatus for dental diagnosis and treatment according to claim 1, further comprising:
a flexible tube extension hose which enables a vacuum tip to be fixed in an arbitrary position in the oral cavity of the patient.

8. The apparatus for dental diagnosis and treatment according to claim 1, further comprising a display, wherein the patient receiving treatment with his/her mouth open can display characters or symbols on the monitor by operating a transmitter in his/her hand for transmitting his/her will to the dentist or the dental assistant.

9. The apparatus for dental diagnosis and treatment according to claim 1, further comprising:
a biological information detector for detecting conditions of the patient's body, and displaying the detected results on the monitor.

10. The apparatus for dental diagnosis and treatment according to claim 1, wherein:
the intraoral camera comprises a hinge for changing an angle of a head portion thereof with respect to the camera body by bending the head portion.

11. The apparatus for dental diagnosis and treatment according to claim 1, wherein:
the intraoral camera is detachably attached to at least any one of a turbine, a micro-motor, an ultrasonic scaler, an electric knife, or a laser device.

12. The apparatus for dental diagnosis and treatment according to claim 1, wherein:
the intraoral camera comprises a tongue depressor detachably mounted to a head portion thereof.

13. An apparatus for dental diagnosis and treatment comprising:
a dentist's chair disposed near a dental treatment table;
an intraoral camera which can capture moving images in a patient's oral cavity;
a first monitor installed at a position where a dentist sitting on the dentist's chair can see, wherein the first monitor displays the image captured by the intraoral camera, and being able to invert the image in vertical direction and reverse the image in a lateral direction;
a second monitor for displaying the image captured by the intraoral camera, and installed at a position where the patient lying on his/her back on the dental treatment table can see; and
a third monitor for displaying the image captured by the intraoral camera, and installed at a position where the dental assistant can see while carrying out assistant work for diagnosis and treatment.

14. An apparatus for dental diagnosis and treatment comprising:
a dentist's chair disposed near a dental treatment table;
an intraoral camera which can capture moving images in a patient's oral cavity;
a monitor installed at a position where a dentist sitting on the dentist's chair can see, wherein the monitor displays the image captured by the intraoral camera, and being able to invert the image in a vertical direction and reverse the image in a lateral direction;
a patient-specific mirror installed at a position where the patient lying on his/her back on the dental treatment table can see, and its angle is adjusted so as to reflect the display obtained by the intraoral camera; and
a dental-assistant-specific mirror installed at a position where the dental assistant can see while carrying out assistant work for diagnosis and treatment, and its angle is adjusted so as to reflect the display obtained by the intraoral camera.

15. The apparatus for dental diagnosis and treatment according to claim 1, wherein the monitor comprises an image inversion control device.

16. The apparatus for dental diagnosis and treatment according claim 1, comprising a recording device which can record the image captured by the intraoral camera.

17. The apparatus for dental diagnosis and treatment according to any claim 1, wherein the switch is a foot switch.

18. The apparatus for dental diagnosis and treatment according to claim 1, wherein:
a cover formed of hydrophilic material is provided on a lens surface of the intraoral camera.

19. The apparatus for dental diagnosis and treatment according to claim 1, wherein:
the intraoral camera can be fixed at a position near the mouth of the patient.

20. The apparatus for dental diagnosis and treatment of claim 5, wherein:
the dental-assistant-specific camera can be combined integrally with a vacuum or a three-way syringe

21. The apparatus for dental diagnosis and treatment of claim 6, wherein:
a camera holding device is formed separately from the intraoral camera.

22. The apparatus for dental diagnosis and treatment according to claim 13, wherein the monitor comprises an image inversion control device.

23. The apparatus for dental diagnosis and treatment according to claim 14, wherein the monitor comprises an image inversion control device.

24. The apparatus for dental diagnosis and treatment according to claim 13, comprising a recording device which can record the image captured by the intraoral camera.

25. The apparatus for dental diagnosis and treatment according to claim 14, comprising a recording device which can record the image captured by the intraoral camera.

26. The apparatus for dental diagnosis and treatment according to claim 2, wherein the switch is a foot switch.

27. The apparatus for dental diagnosis and treatment according to claim 3, wherein the switch is a foot switch.
